(19) United States
(12) Patent Application Publication
(10) Pub. No.: US 2019/0367160 A1
(43) Pub. Date: Dec. 5, 2019

(54) AERODYNAMIC AIRCRAFT WALL COMPRISING AT LEAST ONE VORTEX GENERATOR, AND AIRCRAFT COMPRISING THE SAID AERODYNAMIC WALL

(71) Applicant: Airbus Operations SAS, Toulouse (FR)

(72) Inventors: Erwan KRIER, COLOMIERS (FR); Grégory DE OLIVEIRA, SAINT ALBAN (FR); Thomas BOURDIEU, TOULOUSE (FR); Adrien BAS, TOULOUSE (FR)

(21) Appl. No.: 16/411,900

(22) Filed: May 14, 2019

(30) Foreign Application Priority Data
May 30, 2018 (FR) 1854655

(51) Int. Cl. B64C 23/06; B64D 29/00

(52) U.S. Cl. CPC B64C 23/06; F15D 1/12; B64D 29/00

(57) ABSTRACT

An aerodynamic aircraft wall has external and internal surfaces and is equipped with at least one vortex generator. The vortex generator has at least one active wall projecting with respect to the external surface of the aerodynamic wall and a connecting system connecting the vortex generator to the aerodynamic wall. The connecting system includes at least one support in part pressed firmly against the internal surface of the aerodynamic wall, at least one first fastener connecting the support and the active wall, and at least one second fastener connecting the support and the aerodynamic wall and having a head flush with the external surface of the aerodynamic wall.

### CROSS-REFERENCES TO RELATED APPLICATIONS

This application claims the benefit of the French patent application No. 1854655 filed on May 30, 2018, the entire disclosures of which are incorporated herein by way of reference.

### FIELD OF THE INVENTION

The present application relates to an aerodynamic aircraft wall comprising at least one vortex generator and to an aircraft comprising the aerodynamic wall.

### BACKGROUND OF THE INVENTION

As illustrated in the figures, an aircraft 10 comprises several propulsion assemblies 12 each of which has a nacelle 14 surrounding a propulsion unit. The nacelle 14 comprises at least one aerodynamic wall 16, such as a cowl for example, comprising at least one vortex generator 18, also referred to as a chine or strake.

According to one embodiment visible in FIGS. 3 and 4, the aerodynamic wall 16 has an external surface 16.1 facing towards the outside of the nacelle 14, against which an air flow 20 flows, and an internal surface 16.2 facing towards the inside of the nacelle 14. The vortex generator 18 comprises a T-shaped cross section and has an active wall 22 and a mount 24 projecting with respect to the external surface 16.1 of the aerodynamic wall 16 and connected thereto by fasteners 26.

The mount 24 extends on each side of the active wall 22 and the fasteners 26 are arranged in two rows positioned on each side of the active wall 22. For each fastener 26, the mount 24 and the aerodynamic wall 16 each comprise a through-hole, the through-hole in the mount 24 being countersunk. To complement that, each fastener 26 comprises a shank 28 housed in the through-holes in the mount 24 and in the aerodynamic wall 16, a countersunk head 30 housed in the countersunk part of the through-hole in the mount 24, and an immobilizing system 32, such as a nut for example, connected to the shank 28 and pressed firmly against the aerodynamic wall 16.

The vortex generators 18, positioned on each side of the pylon on the nacelle cowl, make it possible to obtain aerodynamic improvement, notably with regard to the separation of the air flow over the extrados of the wing and by increasing lift during landing phases.

However, the mount 24 of the vortex generator has a forward edge 34 that projects with respect to the external surface 16.1 of the aerodynamic wall 16, and this disrupts the air flow and generates unwanted drag.

The present invention aims to remedy some or all of the drawbacks of the prior art.

### SUMMARY OF THE INVENTION

To this end, one subject of the invention is an aerodynamic aircraft wall comprising a vortex generator, the aerodynamic wall having an external surface over which a flow of air flows during flight, and an internal surface opposite to the external surface, the vortex generator comprising at least one active wall projecting with respect to the external surface of the aerodynamic wall and a connecting system connecting the vortex generator to the aerodynamic wall.

According to the invention, the connecting system comprises at least one support in part pressed firmly against the internal surface of the aerodynamic wall, at least one first fastener connecting the support and the active wall, and at least one second fastener connecting the support and the aerodynamic wall and having a head lying flush with the external surface of the aerodynamic wall.

The invention makes it possible to avoid the appearance of unwanted drag, with a negligible impact on the on-board mass and the assembly time.

According to a first embodiment, the vortex generator comprises, in addition to the active wall, a mount which has a first face flush with the external surface of the aerodynamic wall, and on which the active wall is provided, the active wall and the mount forming a one-piece component. To complement that, each support is a mounting plate, the first fastener(s) connecting the mount and each mounting plate; the aerodynamic wall comprises a cutout configured to house the mount, the cutout and the mount having contours which are identical to within an assembly clearance.

According to another feature, the mount comprises first and second parts, positioned one on each side of the active wall, and each mounting plate extends on each side of the mount and of the cutout. To complement this, the connecting system comprises a first series of first fasteners positioned at the first part of the mount, a second series of first fasteners positioned at the second part of the mount, a first series of second fasteners positioned at a first side of the cutout and a second series of second fasteners positioned at a second side of the cutout.

According to one configuration, the connecting system comprises at least one shim interposed between each mounting plate and the mount and/or the aerodynamic wall.

According to another feature, the assembly clearance provided between the cutout and the mount contains a seal or mastic lying flush with the external surface of the aerodynamic wall.

According to a second embodiment, the active wall comprises at least one extension projecting with respect to the internal surface of the aerodynamic wall, and the aerodynamic wall comprises at least one cutout configured to house the active wall or each extension, each cutout and the active wall or each extension having contours that are identical to within an assembly clearance. To complement this, the connecting system comprises at least one bracket which has a first flange pressed firmly against the extension of the active wall, and a second flange pressed firmly against the internal surface of the aerodynamic wall, the first fastener(s) connecting the extension of the active wall and the first flange of each bracket, and the second fastener(s) connecting the aerodynamic wall and the second flange of each bracket.

According to one configuration, the connecting system comprises first and second brackets positioned one on each side of each extension of the active wall, a first series of second fasteners connecting the second flange of the first bracket and the aerodynamic wall, a second series of second fasteners connecting the second flange of the second bracket and the aerodynamic wall, as well as a series of first fasteners, each of them passing through the two first flanges of the first and second brackets and the extension.

According to another feature, the assembly clearance provided between each cutout in the aerodynamic wall and the active wall or each extension contains a seal or mastic lying flush with the external surface of the aerodynamic wall.

Another subject of the invention is an aircraft comprising an aerodynamic wall according to one of the aforementioned features.

### BRIEF DESCRIPTION OF THE DRAWINGS

Other features and advantages will emerge from the following description of the invention, which description is given solely by way of example, with reference to the appended drawings in which:

FIG. 1 is a front view of an aircraft,

FIG. 2 is a perspective view of a propulsion assembly of the aircraft visible in FIG. 1,

FIG. 3 is a perspective view of part of a nacelle equipped with a vortex generator, illustrating one embodiment of the prior art,

FIG. 4 is a view in section on IV-IV of FIG. 3,

FIG. 5 is a schematic depiction of a vortex generator, illustrating one embodiment of the invention,

FIG. 6 is a view in cross section of part of an aircraft nacelle wall equipped with a vortex generator, illustrating a first embodiment of the invention,

FIG. 7 is a perspective view of part of an aircraft nacelle wall equipped with a vortex generator, illustrating the first embodiment of the invention,

FIG. 8 is a cross section of part of an aircraft nacelle wall equipped with a vortex generator, illustrating a second embodiment of the invention, and

FIG. 9 is a perspective view of part of an aircraft nacelle wall equipped with a vortex generator, illustrating the second embodiment of the invention.

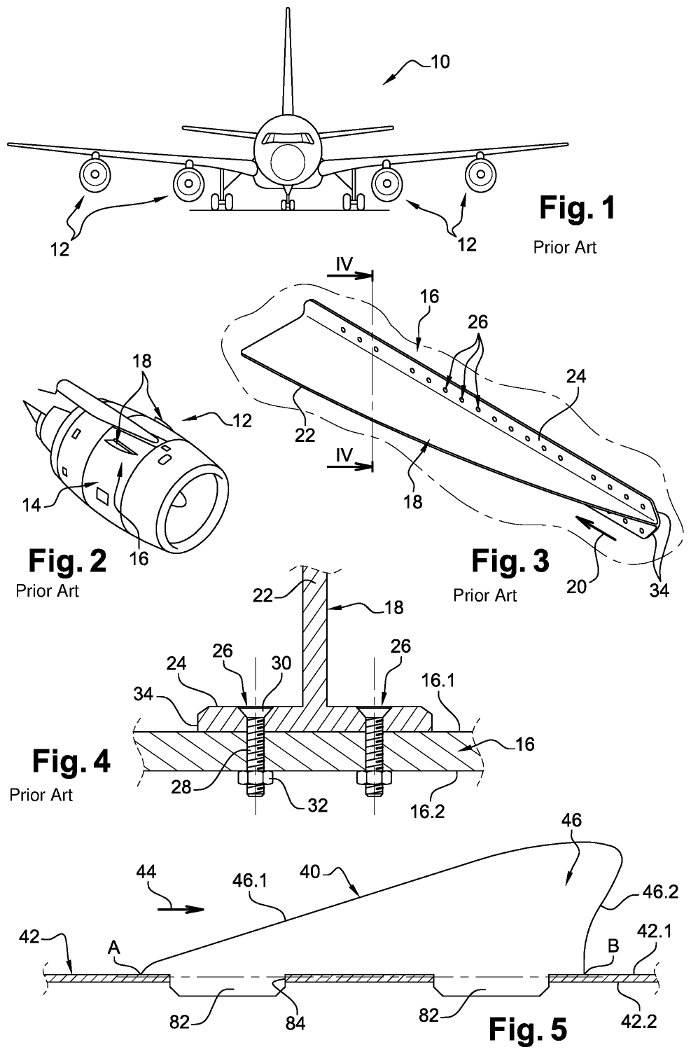

### DETAILED DESCRIPTION OF THE PREFERRED EMBODIMENTS

FIGS. 5 to 9 depict at 40 a vortex generator positioned on an aerodynamic wall 42 of an aircraft nacelle.

Although described in an application to an aircraft nacelle, the invention is not in any way limited to this application and may be applied to any aerodynamic wall of an aircraft, such as, for example, a fuselage, an empennage, a wing, a pylon, a nacelle.

An aerodynamic wall 42 may comprise a single panel or a number of juxtaposed panels.

The aerodynamic wall 42 has an external surface 42.1 against which an air flow 44 flows in flight, and an internal surface 42.2 opposite to the external surface 42.1.

For the remainder of the present application, the terms front and rear refer to the direction in which the air flow 44 flows, this air during flight flowing from the front towards the rear.

What is meant by a vortex generator is any wall projecting with respect to an aerodynamic wall of an aircraft and which is configured to modify the flow of air flowing over the surface of this aerodynamic wall. A vortex generator is also referred to as a chine or strake.

According to the various embodiments visible in FIGS. 5 to 9, the vortex generator 40 comprises at least one substantially planar active wall 46 projecting with respect to the external surface 42.1 of the aerodynamic wall 42. This active wall 46 comprises a leading edge 46.1 and a trailing edge 46.2. The vortex generator 40 comprises a front end A and a rear end B, which are positioned at the external surface 42.1 of the aerodynamic wall 42 when the vortex generator 40 is fitted.

According to one configuration, the active wall 46 is approximately in the shape of a triangle. Thus, the leading edge 46.1 comprises a first, front, end, positioned at the external surface 42.1 of the aerodynamic wall 42, and a second, rear, end connected to the trailing edge 46.2 and separated from the external surface 42.1 of the aerodynamic wall 42.

Of course, the invention is not limited to this configuration.

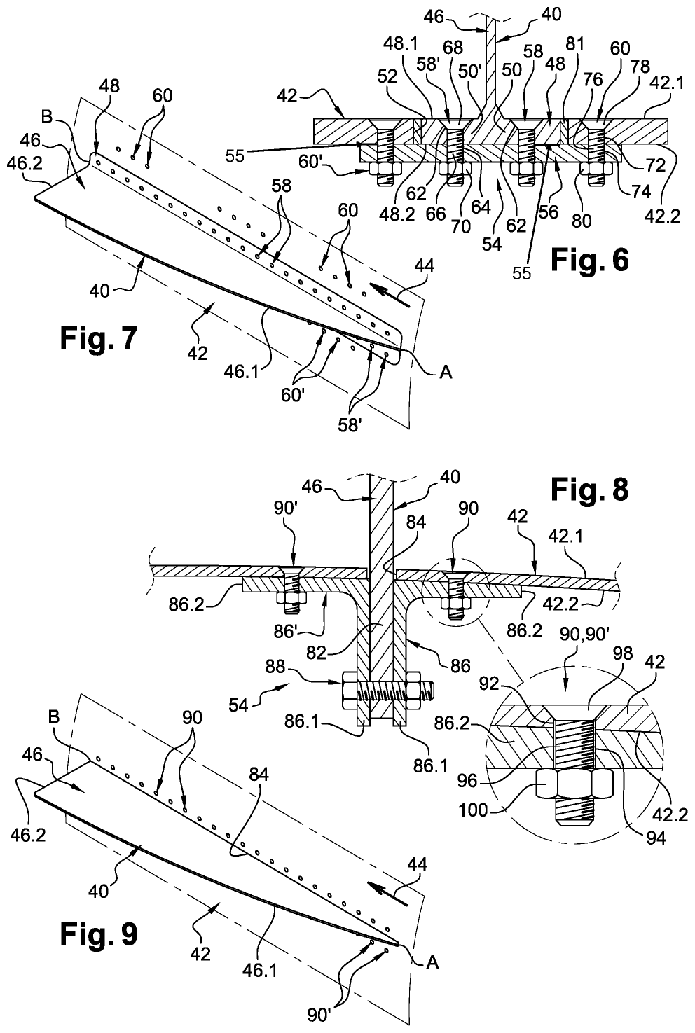

According to a first embodiment visible in FIGS. 6 and 7, the vortex generator 40 comprises, in addition to the active wall 46, a mount 48 which has a first face 48.1 lying flush with the external surface 42.1 of the aerodynamic wall 42, at which the active wall 46 is provided, and a second face 48.2 which may lie flush with the internal surface 42.2 of the aerodynamic wall 42. The active wall 46 and the mount 48 form a one-piece component.

Two faces and/or surfaces are flush if they lie in the same plane and disrupt the air flow 44 virtually not at all.

According to one configuration, the active wall 46 and the mount 48 form a one-piece component with a T-shaped cross section and the mount 48 comprises first and second parts 50, 50′ positioned one on each side of the active wall 46.

To complement that, the aerodynamic wall 42 comprises a cutout 52 configured to house the mount 48 of the vortex generator 40, the cutout 52 having a contour that is identical, to within the mounting clearance, to the contour of the mount 48.

According to the first embodiment, the vortex generator 40 comprises a connecting system 54, connecting the mount 48 of the vortex generator 40 and the aerodynamic wall 42, comprising at least one mounting plate 56 pressed firmly against the second face 48.2 of the mount 48 and the external surface 42.2 of the active wall 42, at least one first fastener 58 connecting the mounting plate 56 and the mount 48, and at least one second fastener 60 connecting the mounting plate 56 and the aerodynamic wall 42.

The connecting system 54 comprises a single mounting plate 56 or several mounting plates 56 distributed along the length of the vortex generator 40 (the length corresponding to the dimension of the vortex generator between the first and second ends A and B).

When the second face 48.2 of the mount 48 and the internal surface 42.2 of the aerodynamic wall 42 are not flush, the connecting system 54 comprises at least one shim interposed between each mounting plate 56 and the mount 48 and/or the aerodynamic wall 42. This shim, which is optional, makes it possible to compensate for clearances if the tolerances on the shapes are not good, in order to obtain a flush surface.

According to one configuration, each mounting plate 56 extends on each side of the mount 48 and of the cutout 52, and the connecting system 54 comprises a first series of first fasteners 58 positioned at the first part 50 of the mount 48 positioned on a first side of the active wall 46, a second series of first fasteners 58′ positioned at the second part 50′ of the mount 48 positioned on a second side of the active wall 46, a first series of second fasteners 60 positioned on a first side of the cutout 52, and a second series of second fasteners 60′ positioned on a second side of the cutout 52.

For each first fastener 58, 58′, the mount 48 comprises a through-hole 62 which has a countersink in the region of the first face 48.1 of the mount 48 and the mounting plate 56 comprises a through-hole 64. To complement that, each first fastener 58, 58′ comprises a shank 66 housed in the through-holes 62, 64 in the mount 48 and in the mounting plate 56, a countersunk head 68 housed in the countersunk part of the through-hole 62 in the mount 48, and an immobilizing system 70, such as a nut for example, connected to the shank 66 and pressed firmly against the mounting plate 56.

For each second fastener 60, 60′, the aerodynamic wall 42 comprises a through-hole 72 which has a countersink in the region of the external surface 42.1 of the aerodynamic wall, and the mounting plate 56 comprises a through-hole 74. To complement that, each second fastener 60, 60′ comprises a shank 76 housed in the through-holes 72, 74 in the aerodynamic wall 42 and in the mounting plate 56, a countersunk head 78 housed in the countersunk part of the through-hole 72 in the aerodynamic wall 42, and an immobilizing system 80, such as a nut for example, connected to the shank 76 and pressed firmly against the mounting plate 56.

According to the first embodiment, the first and second fasteners 58, 58′, 60, 60′ are of the type that lie flush with the external surface 42.2 of the aerodynamic wall 42 and disrupt the air flow 44 virtually not at all.

In order to improve the aerodynamics, the assembly clearance provided between the cutout 52 and the mount 48 contains a seal or mastic 81 lying flush with the external surface 42.1 of the aerodynamic wall.

The method for attaching the vortex generator 40 according to the first embodiment comprises the steps of:

forming the cutout 52,

attaching the mounting plate 56 by drilling simultaneously through the mounting plate 56 and the aerodynamic wall 42 and by fitting the second fasteners 60, 60′,

attaching the vortex generator 40 from the outside of the aerodynamic wall 42 by drilling simultaneously through the mount 48 and the mounting plate 56 and by fitting the first fasteners 58, 58′, and

applying the seal or gasket 81 in the clearance left between the cutout 52 and the mount 48.

According to this first embodiment, the mount 48 is integrated into the aerodynamic wall 42 and offers a bearing surface 48.2 or seating parallel to the aerodynamic wall 42. To complement this, the fixing system 54 comprises an element such as a mounting plate 56 which conforms to the shapes of the seating and of the internal surface 42.2 of the aerodynamic wall 42.

According to a second embodiment visible in FIGS. 5, 8 and 9, the active wall 46 of the vortex generator 40 comprises at least one extension 82 projecting from the internal surface 42.2 of the aerodynamic wall 42. According to one configuration, the active wall 46 comprises a single extension 82 which extends over practically the entire length of the vortex generator 40. According to another configuration visible in FIG. 5, the active wall 46 comprises several disjointed extensions 82 distributed over the length of the vortex generator 40.

To complement this, the aerodynamic wall 42 comprises at least one cutout 84 configured to house the active wall 46 or each extension 82, each cutout 84 and the active wall 46 or each extension 82 having contours that are identical to within an assembly clearance.

According to the second embodiment, the connecting system 54 comprises:

at least one bracket 86 which has a first flange 86.1 pressed firmly against the extension 82 of the active wall 46, and a second flange 86.2 pressed firmly against the internal surface 42.2 of the aerodynamic wall 42,

at least one first fastener 88 connecting the extension 82 of the active wall 46 and the first flange 86.1 of the bracket 86, and

at least one second fastener 90 connecting the aerodynamic wall 42 and the second flange 86.2 of the bracket 86.

According to one configuration, the connecting system 54 comprises two brackets 86, 86′ positioned one on each side of each extension 82 of the active wall 46, the first flanges 86.1 of the first and second brackets 86, 86′ being positioned one on each side of the extension 82 and pressed firmly against the two opposite faces of the extension 82.

According to one configuration, the connecting system 54 comprises a series of first fasteners 88, each of them passing through the two first flanges 86.1 of the brackets 86, 86′ and the extension 82. According to one embodiment, each first fastener 88 is a rivet or a bolt.

The connecting system 54 comprises a first series of second fasteners 90 connecting the second flange 86.2 of the first bracket 86 and the aerodynamic wall 42, these being positioned on a first side of the active wall 46, as well as a second series of second fasteners 90′ connecting the second flange 86.2 of the second bracket 86′ and the aerodynamic wall 42, these being positioned on a second side of the active wall 46.

For each second fastener 90, 90′, the aerodynamic wall 42 comprises a through-hole 92 which has a countersink in the region of the external surface 42.1 of the aerodynamic wall 42, and the second flange 86.2 of each bracket 86, 86′ comprises a through-hole 94. To complement that, each second fastener 90, 90′ comprises a shank 96 housed in the through-holes 92, 94 in the aerodynamic wall 42 and in the second flanges 86.2 of the brackets 86, 86′, a countersunk head 98 housed in the countersunk part of the through-hole 92 in the aerodynamic wall 42, and an immobilizing system 100, such as a nut for example, connected to the shank 96 and pressed firmly against one of the second flanges 86.2 of the brackets 86, 86′.

According to the second embodiment, the first and second flanges 86.1, 86.2 of the brackets 86, 86′ may be perpendicular. In that case, the active wall 46 of the vortex generator 40 is perpendicular to the aerodynamic wall 42. The first and second flanges 86.1, 86.2 of the brackets 86, 86′ may be non-perpendicular. In that case, the active wall 46 of the vortex generator 40 is inclined with respect to the aerodynamic wall 42.

Like in the first embodiment, the assembly clearance provided between each cutout 84 in the aerodynamic wall 42 and the active wall 46 or each extension 82 contains a seal or mastic lying flush with the external surface 42.1 of the aerodynamic wall.

According to this second embodiment, each extension 82 forms a seating which becomes housed in a cutout 84 in the aerodynamic wall 42 and the connecting system 54 comprises an element such as a bracket 86 which conforms to the shapes of the seating and of the internal surface 42.2 of the aerodynamic wall 42.

Whatever the embodiment, the connecting system 54 comprises at least one support, such as a mounting plate 56 or a bracket 86, 86′, in part pressed firmly against the internal surface 42.2 of the aerodynamic wall 42, at least one first fastener 58, 58′, 88 connecting the support and the active wall 46, and at least one second fastener 60, 60′, 90, 90′ connecting the support and the aerodynamic wall 42. Each support is connected to the aerodynamic wall 42 by second fasteners 60, 60′, 90, 90′ having a head flush with the external surface 42.1 of the aerodynamic wall 42. Each support is separate from the active wall 46.

According to another specific feature, the active wall 46 comprises at least one portion which becomes housed in a cutout 52, 84 in the aerodynamic wall. In addition, the region where the active wall 46 and the connecting element meet lies at the internal surface 42.2 of the aerodynamic wall 42, or in an internal zone delimited by the aerodynamic wall 42.

The invention makes it possible to avoid the appearance of unwanted drag which is present in the case of the vortex generators of the prior art, while having a negligible impact on the on-board mass and the assembly time.

While at least one exemplary embodiment of the present invention(s) is disclosed herein, it should be understood that modifications, substitutions and alternatives may be apparent to one of ordinary skill in the art and can be made without departing from the scope of this disclosure. This disclosure is intended to cover any adaptations or variations of the exemplary embodiment(s). In addition, in this disclosure, the terms “comprise” or “comprising” do not exclude other elements or steps, the terms “a” or “one” do not exclude a plural number, and the term “or” means either or both. Furthermore, characteristics or steps which have been described may also be used in combination with other characteristics or steps and in any order unless the disclosure or context suggests otherwise. This disclosure hereby incorporates by reference the complete disclosure of any patent or application from which it claims benefit or priority.

1. An aerodynamic aircraft wall comprising:
a vortex generator,
an external surface over which an air flow flows during flight, and an internal surface opposite to the external surface,
the vortex generator comprising at least one active wall projecting with respect to the external surface of the aerodynamic wall and
a connecting system connecting the vortex generator to the aerodynamic wall,
the connecting system comprising:
at least one support in part pressed firmly against the internal surface of the aerodynamic wall,
at least one first fastener connecting the support and the active wall, and
at least one second fastener connecting the support and the aerodynamic wall.

2. The aerodynamic aircraft wall according to claim 1,
wherein the vortex generator comprises, in addition to the active wall, a mount which has a first face flush with the external surface of the aerodynamic wall, and on which the active wall is provided, the active wall and the mount forming a one-piece component,
wherein the at least one support is a mounting plate, the at least one first fastener connecting the mount and the mounting plate, and
wherein the aerodynamic wall comprises a cutout configured to house the mount, the cutout and the mount having contours which are identical to within an assembly clearance.

3. The aerodynamic aircraft wall according to claim 2,
wherein the mount comprises first and second parts positioned one on each side of the active wall,
wherein the mounting plate extends on each side of the mount and of the cutout, and
wherein the connecting system comprises a first series of first fasteners positioned at the first part of the mount, a second series of first fasteners positioned at the second part of the mount, a first series of second fasteners positioned at a first side of the cutout, and a second series of second fasteners positioned at a second side of the cutout.

4. The aerodynamic aircraft wall according to claim 3, wherein the connecting system comprises at least one shim interposed between the mounting plate and at least one of the mount or the aerodynamic wall.

5. The aerodynamic aircraft wall according to claim 2, wherein the assembly clearance provided between the cutout and the mount contains a seal or mastic lying flush with the external surface of the aerodynamic wall.

6. The aerodynamic aircraft wall according to claim 1, wherein the active wall comprises at least one extension projecting with respect to the internal surface of the aerodynamic wall, wherein the aerodynamic wall comprises at least one cutout configured to house the active wall or each extension, the cutout and the active wall or each extension having contours that are identical to within an assembly clearance, and wherein the connecting system comprises at least one bracket which has a first flange pressed firmly against the extension of the active wall, and a second flange pressed firmly against the internal surface of the aerodynamic wall, the at least one first fastener connecting the extension of the active wall and the first flange of the bracket, and the at least one second fastener connecting the aerodynamic wall and the second flange of the bracket.

7. The aerodynamic aircraft wall according to claim 6, wherein the connecting system comprises first and second brackets positioned one on each side of the extension of the active wall, a first series of second fasteners connecting the second flange of the first bracket and the aerodynamic wall, a second series of second fasteners connecting the second flange of the second bracket and the aerodynamic wall, as well as a series of first fasteners, each of them passing through the two first flanges of the first and second brackets and the extension.

8. The aerodynamic aircraft wall according to claim 6, wherein the assembly clearance provided between the cutout in the aerodynamic wall and the active wall or each extension contains a seal or mastic lying flush with the external surface of the aerodynamic wall.

9. An aircraft comprising an aerodynamic wall according to claim 1.
